(19) United States
(12) Patent Application Publication
(10) Pub. No.: US 2008/0192408 A1
(43) Pub. Date: Aug. 14, 2008

(54) Anti-theft and anti-tipping device for electronic displays

(75) Inventors: Edelen Edward, Baltimore, MD (US); Meninger David, Baltimore, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: J.G. Edelen Company, Inc., Baltimore, MD (US)

(21) Appl. No.: 12/069,253

(22) Filed: Feb. 8, 2008

Related U.S. Application Data
(60) Provisional application No. 60/900,135, filed on Feb. 8, 2007.

(51) Int. Cl. H02B 1/00

(52) U.S. Cl. 361/600

(57) ABSTRACT

Disclosed is a rigid bracket configured for fitted attachment to the underside of a base for an electronic display, such as a flat screen television. The bracket is shaped to fit within the outer perimeter of the base of the display and may be provided notches along the outer edge to accommodate feet that are mounted to the underside of the base of the display. The bracket is also provided a connection device for fixing the bracket (and thus the display base) to a platform on which the display is positioned.

### CROSS REFERENCE TO RELATED APPLICATION

This application is based upon and claims benefit of copending and co-owned U.S. Provisional Patent Application Ser. No. 60/900,135 entitled “Anti-Theft and Anti-Tipping Device for Electronic Displays”, filed with the U.S. Patent and Trademark Office on Feb. 8, 2007, by the inventors herein, the specification of which is incorporated herein by reference in its entirety.

### BACKGROUND OF THE INVENTION

1. Field of the Invention

The invention comprises a locking and anti-tipping device for a display, such as a flat screen TV, which device secures the display to any table top or cabinet to prevent any accidental tipping and theft.

2. Background of the Invention

Security devices for connecting an electronic device to a surface at the base of the electronic device are shown by U.S. Pat. Nos. 3,908,942; 4,305,266; 4,613,109; 4,739,637; 5,209,445; 5,383,641; 5,697,233; 5,775,665; and 6,926,244. For example, U.S. Pat. No. 3,908,942 discloses a two-piece bracket security assembly for locking a television to a counter top. One piece is attached to the underside of the television base, while the other piece is attached to the counter top surface. A horizontal bolt and nut must be retracted to allow removal of the television from the counter top.

U.S. Pat. No. 4,305,266 discloses a two-piece locking apparatus for locking an electronic device to a surface. One piece is attached to the underside of the device, while the other attaches to the particular surface.

U.S. Pat. No. 5,383,641 discloses a two piece television support member security mounting assembly in which the television is secured to a support tray by a set of security fasteners, and the support tray is rotatably connected to a mounting member that is screwed to a counter surface.

While the above described prior art attempts may have had marginal success in securing televisions or other electronic display devices to a surface, their configurations tend to be bulky and at times even obtrusive, thus limiting their wide-scale adoption. Therefore, there remains a need for a simple and effective product designed to enable a secure attachment of a display device to any table top or cabinet in order to prevent any accidental tipping and/or theft, in which the product is unobtrusive but maintains the ability to fully secure the display.

### SUMMARY OF THE INVENTION

Disclosed herein is a device for securing an electronic display to a surface, such as a television stand or other furniture. The device comprises a single support member that is preferably not visible to a viewer of the electronic display once installed, and particularly not visible from the front of such electronic display. The support member has a top side and a bottom side. At least one aperture allows a device-fastening member to connect the top side of the support member to the base of the display device. A surface fastening member connects the bottom side of the support member to the surface, in turn securing the base of the electronic display to the surface.

Some embodiments disclosed herein include elongate members that extend away from the support member and allow it to be secured to the surface. In one embodiment, the elongate member extends away from the support element and wraps around an edge of the surface, allowing the device to be fastened to the rear of the stand or other furniture item to which the electronic display is to be secured. In another embodiment, the elongate member or arm is connected to a bracket that wraps around an edge of the surface and is secured onto the back of the item to which the electronic display is to be connected.

In each embodiment, the support member is preferably integral formed, in contrast to being formed of separate elements joined together such as by way of pivoting connections or the like, which feature simplifies the manufacture of the support member and likewise eases installation while still provide a secure connection to the surface on which the display is to be mounted.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a front view of a device according to certain aspects of a first particularly preferred embodiment of the present invention.

FIG. 2 is a bottom view of a support member for use with the device of FIG. 1.

FIG. 3 is a bottom view of an alternative support member for use with the device of FIG. 1.

FIG. 4 is a bottom view of another alternative support member with one elongate member and a bracket to connect to a desired surface.

FIG. 4A is a front, perspective view of a bracket that may be used with some embodiments of the present invention.

FIG. 4B is a top view of a bracket that may be used with some embodiments of the present invention.

FIG. 4C is a side view of a bracket that may be used with some embodiments of the present invention.

FIG. 4D is a front view of a bracket that may be used with some embodiments of the present invention.

FIG. 5 is a bottom view of another alternative support member.

FIG. 6 is a bottom view of another alternative support member.

FIG. 7 is a schematic diagram of a method according to another aspect of a particularly preferred embodiment of the present invention.

FIG. 8 is a schematic diagram of a method according to another aspect of a particular preferred embodiment of the present invention.

### DETAILED DESCRIPTION OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

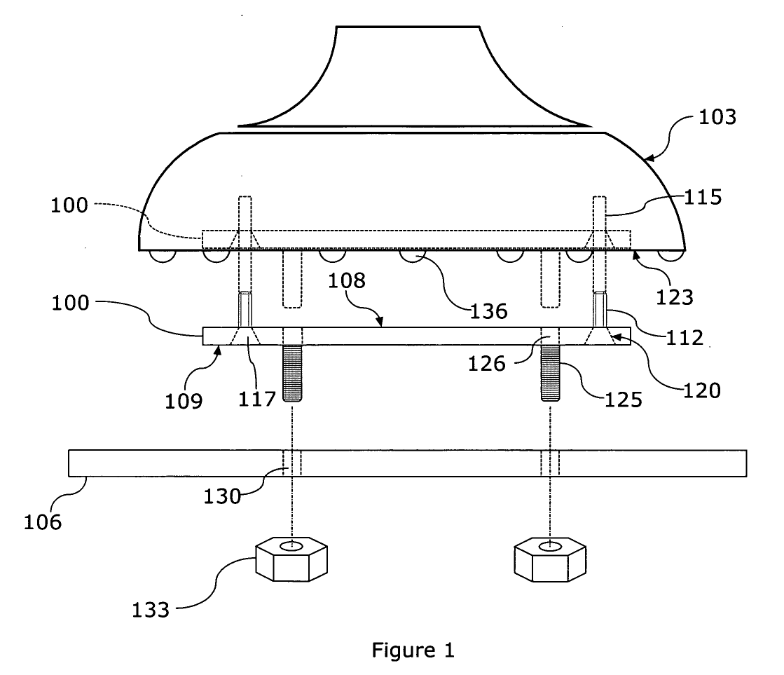

The present invention contemplates a device for securing an electronic display, such as a television set, a computer display, or other device that a user intends to secure to a particular surface. As shown in FIG. 1, the device consists of a single support member 100 sized and configured so as to fit the underside 123 of the base 103 of a display device. The support member 100 may be connected to a desired surface 106 in such a way that the support member 100 is not easily visible once secured to both the base 103 of the device and the surface 106. In some embodiments of the present invention, the support member 100 is not visible from any angle, while in other embodiments it is only visible from one or more sides of the display, but not from the front of the display. The surface 106 may be a television stand, desk, bureau, or other furniture upon which an electronic display is to be positioned and secured. Additionally, the support member 100 does not interfere with the base's feet 136, allowing the base 103 to sit on the surface 106 as if the support member 100 was not connected to the base 100.

In some embodiments of the present invention, a single support member 100 is provided that has a top side 108 and a bottom side 109. The support member 100 connects to the base 103 of the electronic display through one or more device fastening members 112. The device fastening members 112 may be screws, bolts or the like, that connect to pre-existing fastening receptacles 115 on the underside 123 of the base 103. The device fastening members 112 extend upwardly through channels 117 in the support member 100 that extend from the bottom side 109 to the top side 108 of the support member 100. In some embodiments of the present invention, the channels 117 have a counter-sunk component 120 that allows device fastening members 112 to sit flush against the bottom side 109 once installed. The device fastening members 112 allow the top side 108 of the support member 100 to connect to the base 103 of the display device in such a way that the bottom side 109 of the support member 100 does not protrude below the underside 123 of the base 163 as shown by the phantom lines on FIG. 1.

The support member 100 is connected to the surface 106 through a number of surface fastening members 125. It is contemplated that in some embodiments of the present invention, the surface fastening members 125 protrude downwardly from the bottom side 109 of the support member 100 and are an integral part of the support member 100, i.e., the surface fastening members 125 and the support member 100 are cast together as a single element. In other embodiments of the present invention, the surface fastening members 125 extend downwardly through surface connecting channels 126 that extend from the top side 108 to the bottom side 109 of the support member 100. A person of ordinary skill in the art would realize that the surface fastening members 125, if not integrally connected to the support member 100, might be secured by fastening means that prevents them from turning upon installation. For example, the surface fastening members 125 may have hexagonal heads that fit into hexagonal shaped portions of the surface connecting channels 126 closest to the top side 108 of the support member 100. The surface fastening members 125 may also be welded to the support member 100. It is also contemplated that there may be as few as one surface fastening member 125 that connects the support member 100 to the surface 106.

To affix a display to surface 106, after the support member 100 is secured to the base 103 by the device fastening members 112, the support member 100 is then placed on the surface 106. The surface fastening members 125 extend through the surface channels 130 and are secured by locking members 133. The locking members 133 may be specially manufactured nuts that screw onto the surface fastening members 125, which are threaded to accept the nuts. The locking members 133 may be specially manufactured in such a way that they can only be installed and removed through the use of special tools. A person of ordinary skill in the art would recognize that there are many other ways to secure the surface fastening members 125 to the surface 106 to prevent removal by unauthorized individuals.

Support member 100 is preferably configured for fitted attachment to the underside 123 of a base 103 for an electronic display, such as a flat screen television. The bracket or support member 100 may be shaped to fit within the outer perimeter of the base 100 of the display, and may be provided notches along the outer edge to accommodate feet 136 that are mounted to the underside 123 of the base 103 of the display.

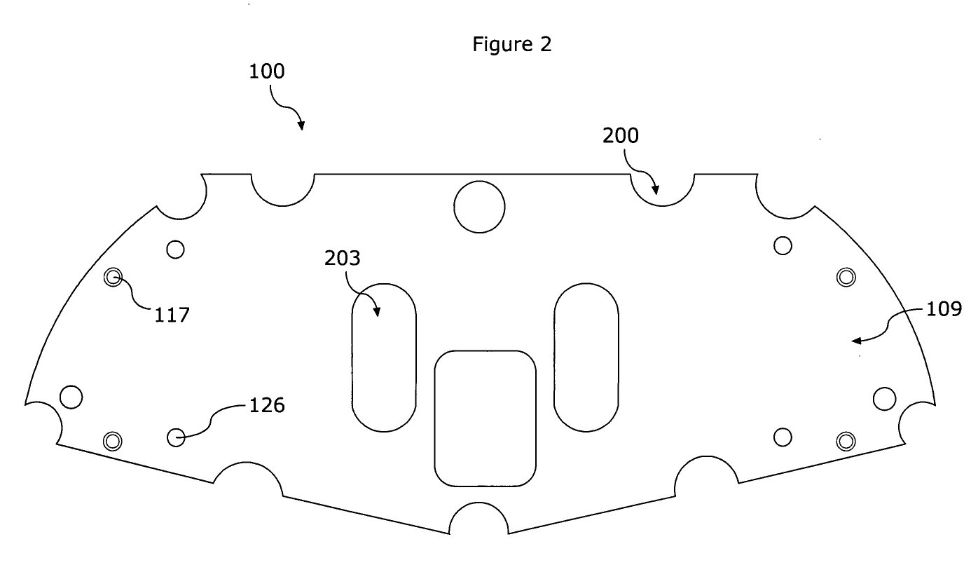

As shown in the bottom view of FIG. 2, a bottom side 109 of one embodiment of the support member 100 is presented. The support member 100 has appertures 200 that accommodate the feet 136 of the base 103. In one example of the present invention, as shown in FIG. 2, four surface connecting channels 126 are provided. In other embodiments there may be more or less than four surface connecting channels 126. The surface connecting channels 126 accommodate the surface fastening members 125, which are preferably specially fitted or welded to the channels to prevent them from turning when the locking members 133 are secured. In other embodiments, the surface fastening members 125 are cast at the same time as the support member 100 in the same position where the surface connecting channels 126 of FIG. 2 are displayed. Additionally, the support member 100 may include a number of openings 203 that allow access to different portions of the base 103.

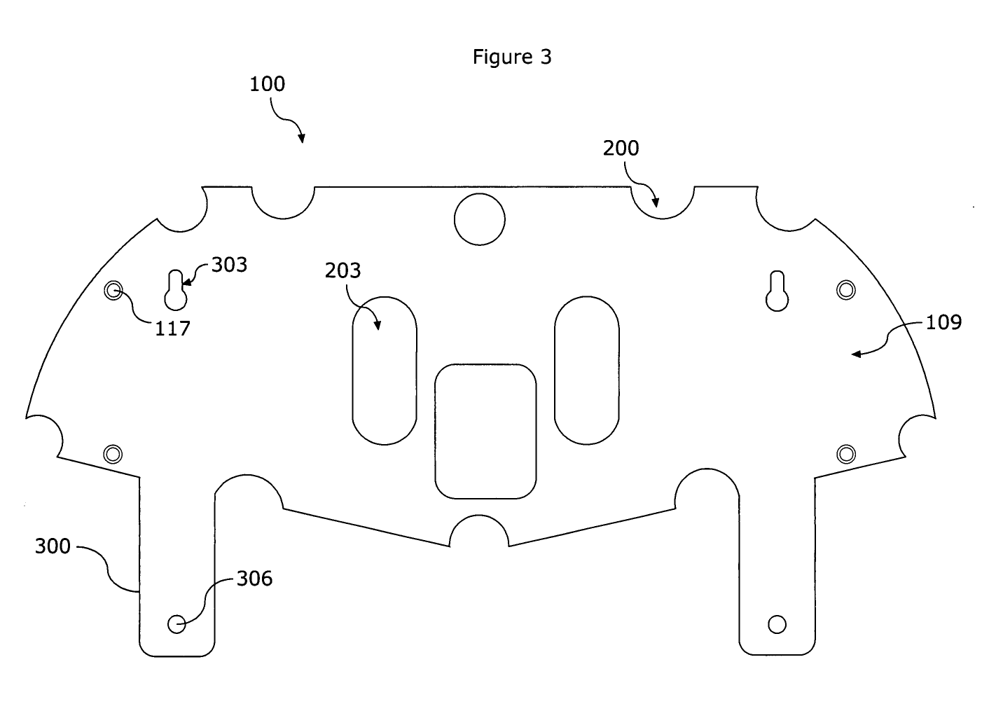

In another embodiment of the present invention, the support member 100 may have one or more elongate members 300 extending away from the support member 100 as shown on FIG. 3. Each elongate member 300 may include surface connecting channels 306 that allow the surface fastening members 125 to connect the support member 100 to the surface 106. In this embodiment, keyholes 303 may be provided. It is contemplated that keyhole screws may be secured to the surface 106, in which case the support member 100 is secured to surface 106 through the keyholes 303 and the surface fastening members 125 extending through the surface connecting channels 306. The support element 100, as in FIG. 1, is secured to the base 103 by device fastening members 112 through the device connecting channels 117. In some embodiments of the present invention, the elongate members 300 may be visible from the back or sides after installation. In other embodiments, the elongate members may not be visible from the front of the display or from any side after installation.

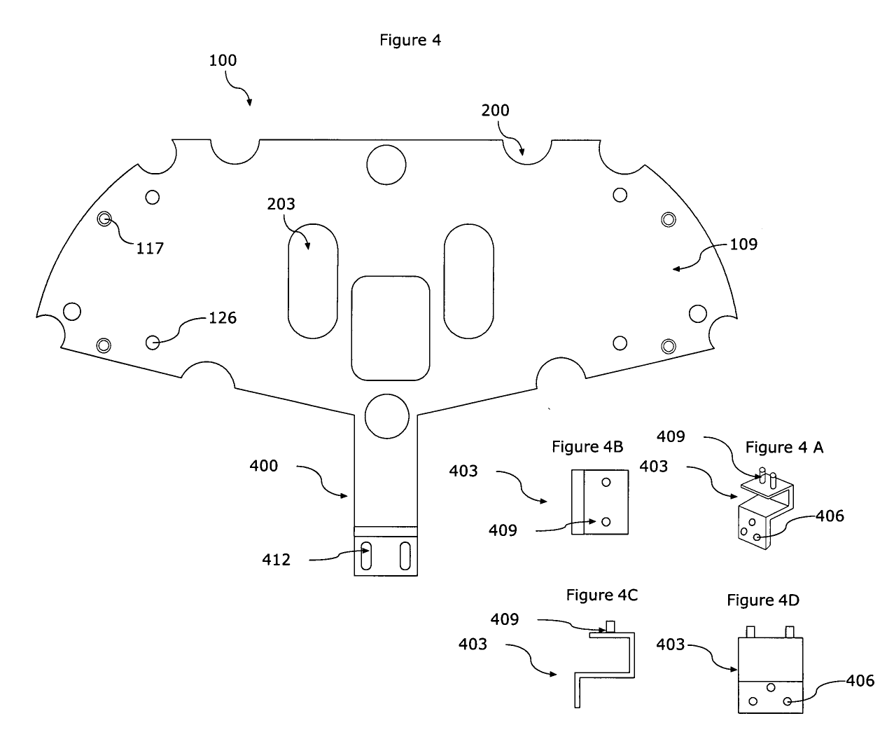

In a further embodiment, as shown on FIG. 4, the device for securing an electronic display is configured with an arm 400 extending away from the back of the support member 100 and connecting to a bracket 403 that bends around a side of the surface 106. The arm allows attachment to one side of the surface 106 on which the display is to be positioned. The arm 400 is preferably configured to wrap around the rear side of the surface 106, and is attached to the surface 106 using special security screws. In some embodiments of the present invention, the arm 400 consists of a single piece that wraps around one side of the surface. In further embodiments, the arm 400 may be attached to a bracket 403.

The bracket 403 shown in FIGS. 4A, 4B, 4C and 4D may be constructed in different configurations to accommodate attachment of the support member 100 to the surface 106. For example, there may be one or more security device openings 406. In some embodiments, there may be three security device openings 406, as shown in FIGS. 4A and 4D. In other embodiments there may be up to eight security device openings 406. The bracket 403 may be connected to the surface 106 by security devices and security device locking members, such as bolts and safety nuts. The arm 400 may also be attached to the bracket 403 through arm fastening elements 409, which extend upwardly through arm fastening channels 412 in the distal portion of the arm 400. The arm 400 may be secured to the bracket 403 through arm fastening element locking members, such as security nuts.

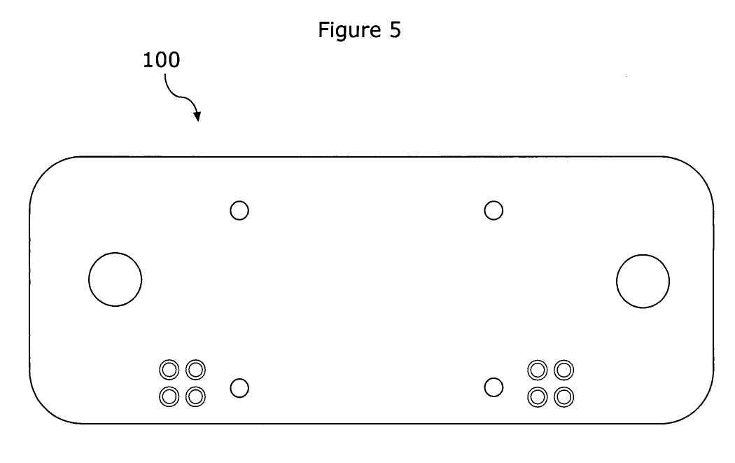

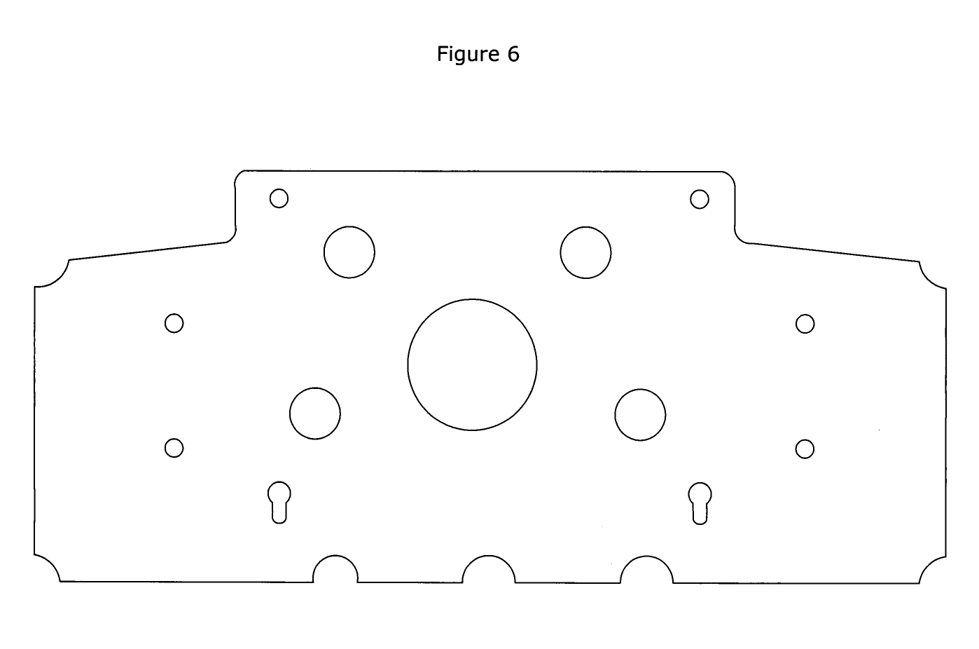

The support element 100 of the present invention may be provided in various configurations that allow it to be concealed within the base 103. In FIGS. 2 through 4, the support element is presented in a semicircular configuration, which may fit a particular electronic device model. In FIGS. 5 and 6 generally rectangular configurations are presented. It is to be understood that a person of ordinary skill in the art may configure the support element 100 in such a way as to be concealed within the base of an electronic display device.

It is contemplated that the support member 100 of the present invention may be constructed of many different materials, such as hot rolled, pickled and oiled steel of different gauges. The support member 100 may also be finished in different ways such as providing a dull black powder coat.

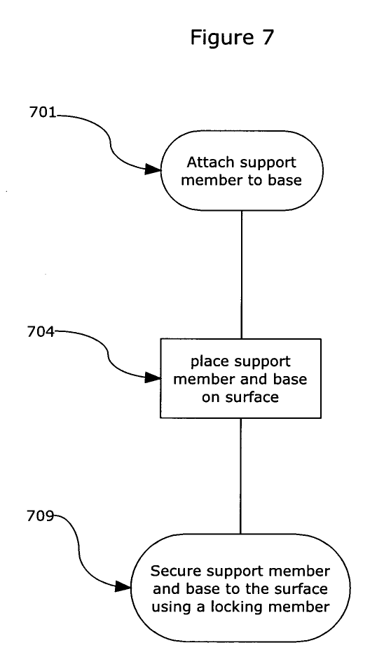

The present invention also contemplates a method for securing an electronic display device to a surface as shown on FIG. 7. In a first step 701, the single support member sized and configured so as not to be visible from the front of the base, having a top side and a bottom side, at least one channel that allows a device fastening member extending upwardly through the support member to connect the top side of the support member to an underside of a base of the display device, and at least one surface fastening member extending downwardly from the support member to connect the bottom side of the support member to the surface, is attached to the base of the electronic display using the device fastening members. In a second step 704, the single support member (now attached to the base) is placed on the surface. In a third step 709, the support member and attached base are secured to the surface utilizing a locking member, such as a specially manufactured nut that can only be removed with a special tool.

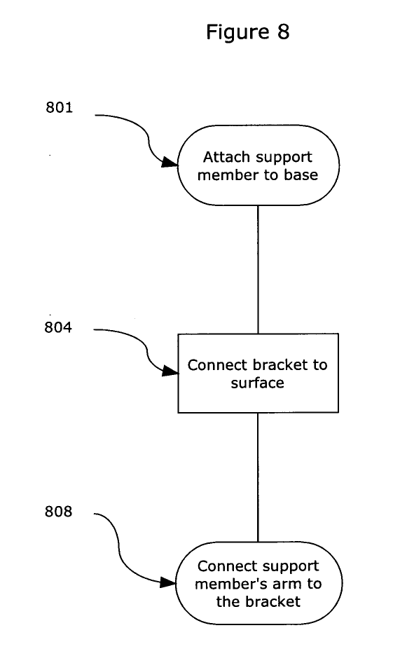

In a further preferred embodiment of the present invention, a method for securing an electronic display device to a surface, as shown on FIG. 8, consists of a first step 801 where a single support member sized and configured so as to fit an underside of a base is attached to the base of the electronic display. The support member is also configured so as to not be visible from the front of the base and has a top side and a bottom side. In addition, the support member has at least one channel configured to receive a device fastening member. The device fastening member is also configured to extend through the support member to connect the top side of the support member to the underside of the base. The support member also includes an arm that has arm fastening channels for securing the support member to a bracket. In a second step 804, the bracket is connected to the surface. It is contemplated that the bracket may be configured to connect to one of the sides of the surface by wrapping around the edge of said surface. The bracket is further secured to the surface by a security device that extends through security device openings in the bracket and a security device locking member. In a third step 808, an arm fastening element on the bracket is connected to the arm through the arm fastening channels. The arm fastening elements are secured by a locking member configured so as to lock said arm to said arm fastening element. The steps of the present method do not have to be performed in the order described herein. For example, the bracket may be attached to the arm before being attached to the surface.

It will be appreciated by persons skilled in the art that numerous variations and/or modifications may be made to the invention as shown in the specific embodiments without departing from the spirit or scope of the invention as broadly described. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein. The present embodiments are, therefore, to be considered in all respects as illustrative and not restrictive.

What is claimed is:

1. An apparatus for securing a display device to a surface, comprising:
an integrally formed support member, said support member being sized and configured so as to fit an underside of a base so as to not be visible from the front of the base, said support member having a top side and a bottom side;
at least one channel configured to receive a base fastening member extending upwardly through the support member to connect the top side of the support member to the underside of the base;
a surface fastening member configured to connect the bottom side of the support member to the surface; and
a locking member configured to receive said surface fastening member so as to lock said single support member to the surface.

2. The apparatus of claim 1, further comprising at least one surface connecting channel configured to receive said surface fastening member.

3. The apparatus of claim 1, further comprising at least one aperture configured to receive a foot of the base so as to allow said foot to extend below the bottom side of said single support member when said single support member is installed on said base.

4. The apparatus of claim 1, wherein the device fastening member is configured and positioned to connect to a fastening receptacle in the base.

5. The apparatus of claim 1, further comprising an elongate member extending outward from said support member and said base and configured so as to not be visible from the front of said base.

6. The apparatus of claim 5, wherein said elongate member further comprises a surface connecting channel configured to receive said surface fastening member.

7. An apparatus for securing a display device to a surface, comprising:
an integrally formed support member, said support member being sized and configured so as to fit an underside of a base so as to not be visible from the front of the base, said support member having a top side and a bottom side;
at least one channel configured to receive a device fastening member extending upwardly through the support member to connect the top side of the support member to the underside of the base;
an arm extending away from the support member;
a bracket receiving said arm and configured for attachment to the surface;
a security device configured to attach the bracket to the surface; and
a security device locking member configured to receive said security device so as to lock said bracket to the surface.

8. The apparatus of claim 7, wherein said arm further comprises an arm fastening channel, and said bracket further comprises an arm fastening element configured for insertion into said arm fastening channel.

9. The apparatus of claim 7, wherein said bracket further comprises:
a security device opening configured to receive said security device; and
an arm fastening element configured to receive a portion of said arm.

10. The apparatus of claim 9, further comprising:
an arm fastening element locking member configured to lock said arm to said arm fastening element.

11. A method for securing an electronic display device to a surface, comprising:
attaching an integrally formed support member to an underside of a base of said display device, said support member being sized and configured so as to fit the underside of the base so as to not be visible from the front of the display device, said support member having a top side and a bottom side, said support member further comprising at least one channel configured to receive a device fastening member extending upwardly through the support member to connect the top side of the support member to the underside of the base, and at least one surface fastening member extending downwardly from the support member to connect the bottom side of the support member to the surface, wherein said support member is attached to the base utilizing the device fastening members;
placing the support member attached to the base on the surface such that said surface fastening member extends through said surface; and
securing the support member to the surface utilizing a locking member positioned below said surface.

12. The method of claim 11, further comprising drilling surface channels through said surface, said channels being configured to receive said surface fastening member.
